(19) United States
(12) Patent Application Publication
(10) Pub. No.: US 2026/0043344 A1
(43) Pub. Date: Feb. 12, 2026

(54) FREE PISTON ENGINE

(71) Applicant: Manuel Exposito CARBALLADA, Santa Catarina (BR)

(72) Inventor: Manuel Exposito CARBALLADA, Santa Catarina (BR)

(21) Appl. No.: 19/099,664

(22) PCT Filed: Jul. 28, 2023
(86) PCT No.: PCT/BR2023/050246

§ 371 Date: Jan. 29, 2025

(30) Foreign Application Priority Data
Mar. 8, 2022 (BR) 1020220153574

(51) Int. Cl. F02B 71/00; F02B 75/18; F02B 75/22; F02F 3/28

(52) U.S. Cl. CPC F02B 71/00; F02B 75/222; F02F 3/28; F02B 2075/1812

(57) ABSTRACT

A structural arrangement for an internal combustion engine and/or star shaped air compressor, without a crankshaft and connecting rods and with one or more surrounded pistons, being able to use any fuels in the case of the engine, liquid or gaseous including hydrogen and obtain high thermodynamic efficiency. The engine and/or air compressor has an arrangement that makes it possible to transmit linear movement into circular movement by means of a ring together with an eccentric and with a coupling structure, The structure joins the pistons to the ring, which can be polygonal in the case of the use of at least three pistons or welded in the case of one or two pistons.

### TECHNOLOGICAL SECTOR OF THE INVENTION

The present invention belongs to the engine engineering sector, and refers, more specifically, to a structural arrangement for an internal combustion engine and/or star shaped air compressor, without a crankshaft and connecting rods and with one or more surrounded pistons, being able to use any fuels in the case of the engine, liquid or gaseous including hydrogen (aiming to have no emissions with hydrogen) and obtain high thermodynamic efficiency with any fuel.

### PRIOR ART

A free piston engine, also known as an opposed piston engine, is a type of internal combustion engine that has a special piston configuration. Unlike conventional piston engines, in which the pistons are connected to a crankshaft, the pistons in a free piston engine move independently, without a direct mechanical connection to the crankshaft.

These engines usually have two pistons moving in opposite directions inside a common cylinder. Each piston has its own combustion chamber and an intake and exhaust valve. Combustion takes place alternately in each chamber, driving the pistons forward and backward.

The main advantage of free piston engines is the elimination of the need for a crankshaft, which reduces mechanical losses and increases efficiency. In addition, these engines have a simpler and more compact design compared to conventional piston engines. They also offer more uniform and smoother combustion, resulting in less vibration and noise.

Another advantage is that these engines can use different types of fuel, including gasoline, diesel, natural gas and even hydrogen. This makes them versatile in terms of fuel options.

However, free piston engines also present significant challenges. One of the main challenges is ensuring proper synchronization of the pistons, to avoid collisions or interference during movement. In addition, combustion rate control and thermal management are critical aspects to ensure the efficient performance and durability of these engines.

But mainly, current free piston engines cannot transmit linear motion directly to the shaft, as they have no means of coupling. Conventional models only transmit force or work through the air they compress themselves or another gas.

Although free piston engines offer some interesting advantages, they are still in the development phase and are not widely used in the automotive industry. However, several companies and researchers continue to explore its potential in search of more efficient and sustainable solutions for vehicle propulsion.

### ADVANCES OF THE INVENTION

The present invention relates to an internal combustion engine and/or air compressor which has an arrangement that makes it possible to transmit the linear movement into circular movement by means of a ring together with an eccentric and with a coupling structure; the said structure is what joins the pistons to the ring, which can be polygonal in the case of the use of at least three pistons or welded in the case of one or two pistons involved.

With the arrangement shown, in its different configurations, it achieves greater thermodynamic efficiency with respect to current engines and in absolutely all other aspects too (environmental, mechanical, thermodynamic, economic, consumption etc.), since it also has a much more efficient thermodynamic cycle.

Specifically, the present invention relates to an internal combustion engine and/or air compressor with improved total efficiency, better thermodynamic efficiency, reduced dimensions, longer service life, more power/weight ratio and reduction (even double) of gas emissions to the environment than any other engine, and if it uses hydrogen it would not generate emissions without losing any of the previous characteristics.

### BRIEF DESCRIPTION OF THE DRAWINGS

In order that the present invention may be fully understood and put into practice by any technician in this technological sector, it will be described in a clear, concise and sufficient manner, based on the attached drawings, which illustrate and support it, listed below:

FIG. 1 shows a perspective view of the engine, highlighting the components, exemplified by an arrangement with 6 pistons;

FIG. 2 shows the front view of the engine, highlighting the components, exemplified by an arrangement with 6 pistons;

FIG. 3 represents the perspective view of the engine components;

FIG. 4 represents the perspective view of the engine, exemplified by an arrangement of 2 engines, each with 2 pistons around it;

FIG. 5 represents the perspective view of the engine, highlighting the components for a 1 or 2 piston engine arrangement;

FIG. 6 represents the graph of the P-V (pressure and volume) thermodynamic chart of the engine.

### DETAILED DESCRIPTION OF THE INVENTION

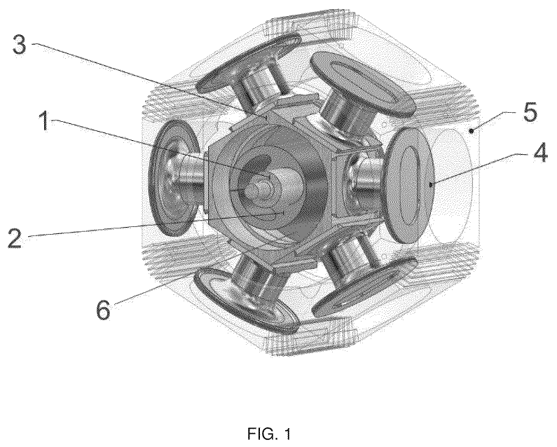

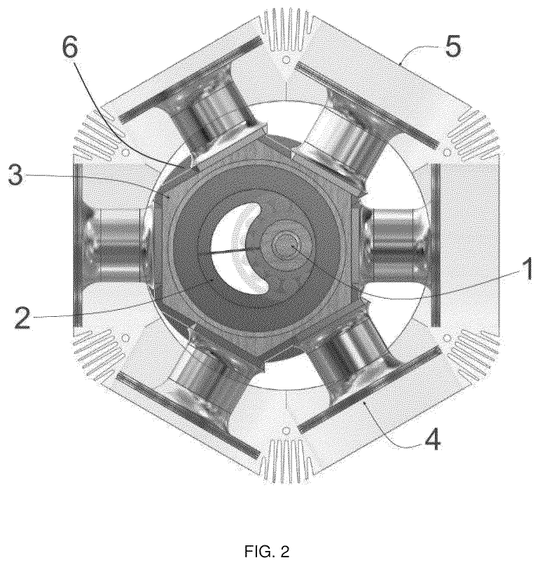

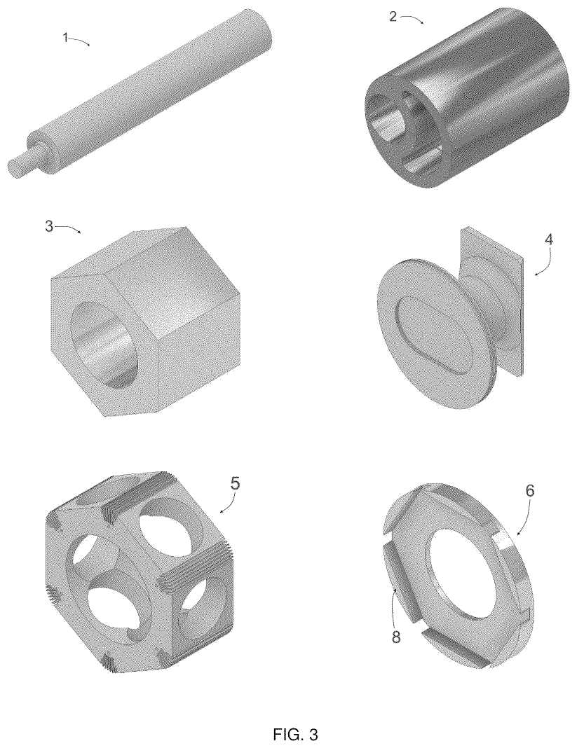

As shown in FIGS. 1 to 3, the combustion engine and/or compressor is formed by an arrangement of three or more pistons (4), which are coupled to the polygonal ring (3) in a sliding manner and limited by the tabs (8) of the clamp (6) mounted on said ring (3); the ring (3) has an eccentric (2) in the center and together they transform the linear movement of the pistons (4) into circular movement on the shaft (1), the shaft (1) being welded or fixed to the eccentric (2). This shaft (1) is through, crosses both sides, where the power and/or work of the engine comes out which is then coupled to one or more external equipment at one or both ends, being closed by two covers (not shown) that serve as support in front of and behind the block (5) for the shaft, this block being the main support structure of the engine.

Alternatively, the polygonal ring (3) which has sides corresponding to the number of pistons (4) may also be cylindrical, having a proportional space for the allocation of components.

The motor shaft (1) rotates together with the eccentric (2). However, during the movement of the shaft (1) plus the eccentric (2) the assembly of the polygonal ring (3) supporting the pistons (4) remains only with a translation movement without rotating, as it is free secured by its inner cylinder to the eccentric and its outer polygon in a sliding way to the pistons (4). The clamp (6) is fixed to the ring (3) and allows the sliding movement of the pistons (4) as it holds them close to the ring so that they do not remain loose.

In the present invention, the combustion cylinder heads are placed externally in front of the pistons (4) fixed in the block (5) to form the combustion chamber and must include synchronized valves.

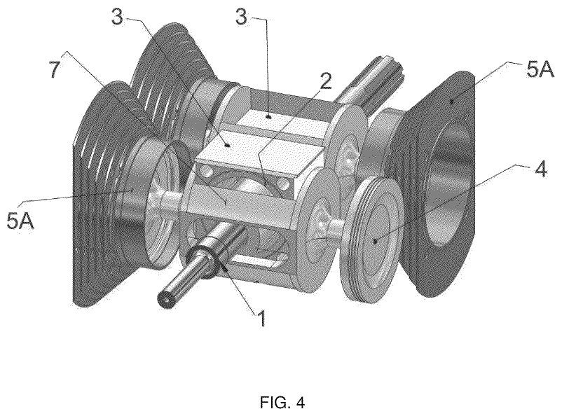

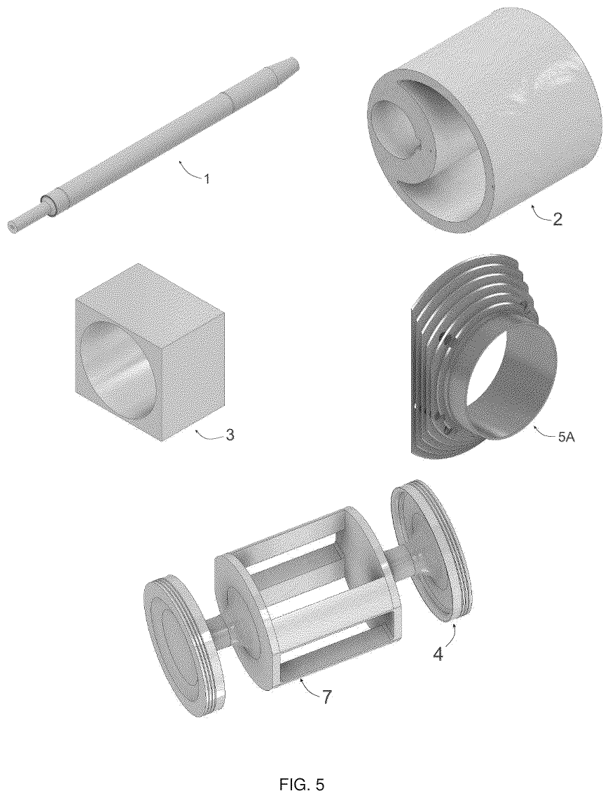

As illustrated in FIGS. 4 and 5, alternatively, in an arrangement that contains only one or two pistons, the construction is composed of pistons (4) that are integrated into the blocks (5A), and are welded to a coupling structure (7) which internally receives the four-sided polygonal ring (3) (using only two opposite sides for the pistons to slide) being positioned orthogonally to the shaft (1) joined to the eccentric (2), inserted into the ring (3).

The pistons (4) are slid into the ring (3) which has 4 sides using only two; the two pistons are integrated sliding to the blocks (5A), and the pistons are joined together with a coupling structure (7) which replaces the clamp (6), and in this case, the structure (7) is fixed, welded or integrated to the two pistons as a single piece.

The pistons (4) transmit their linear movement in a sliding way to the ring (3) which does not only rotate, but also moves, and this ring pushes on the eccentric which rotates inside the ring, converting this linear movement of the pistons (4) into circular movement of the shaft.

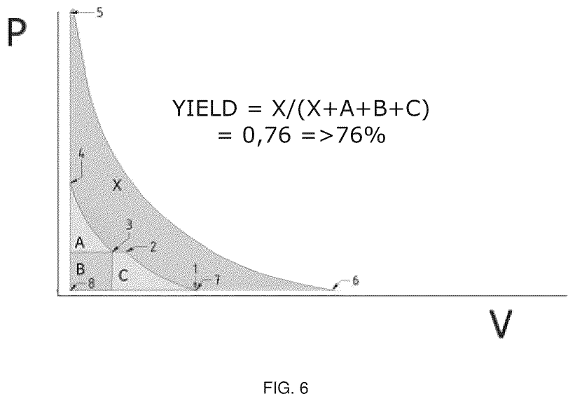

FIG. 6 illustrates the representative theoretical thermodynamic pressure-volume chart in the case of a 4-stroke engine. A technician recognizes that this particular thermodynamic cycle is very efficient, because the values on the chart represent the surfaces of each letter and this is how the yield is theoretically calculated, and this chart is only representative and illustrative.

The structural arrangement presented here provides the technique of an engine in which the first part of the cycle represented in the thermodynamic chart in sequence from point 1 to point 4 simulates the compression in the engine, and occurs in one or more stages (times), with intermediate cooling of the air (see between points 2 and 3 that there is a reduction in volume and constant pressure), If it is more than one stage, then comes the explosion at point 4 and the pressure rises to point 5 with the chamber completely closed to the minimum volume, which increases the pressure to a very high value, and with the high pressure the gases expand to point 6 (which is twice the expansion of current engines) taking full advantage of the amount of energy, which is transmitted to the shaft (1) through the eccentric (2), which from point 6 empties the cylinder of gases completely to point 8, and then filling again to point 6 with new air and fuel, returns to multiple intakes and part of this mixture to point 7 where the valve closes (which is approximately 50% of the volume) to start the cycle again at point 1. The previous description, although for a 4-stroke engine, allows achieving the same yield for a 2-stroke engine where the emptying and filling with new pre-compressed air and fuel from the cylinder is done at once between point 6 and the point 7 on the thermodynamic chart, thus avoiding an extra turn of the shaft in each cycle.

The thermodynamic cycle is very efficient, because the initial compression can be carried out in one or more stages, with intermediate cooling if there is more than one stage, which considerably reduces the work required to carry out the compression, being able to achieve more efficiency to take advantage of the maximum gas energy. However, this engine makes the most of the energy generated by the fuel with minimum waste.

In the design of these engines and/or compressors any of the possible combinations can be used, being able to carry out one or several different sets on the same shaft, as well as varying quantities of pistons.

Last but not least, this engine contributes to the health of the planet, so it can be considered without a doubt, a green invention, as global warming would be reduced in a very high proportion, since there would be a reduction in CO₂ levels to the atmosphere and with hydrogen zero emissions. Furthermore, it can be used for motorcycles, cars, boats, airplanes, machinery, power plants etc.

It is important to point out that the figures and descriptions made do not have the effect of limiting the ways of carrying out the inventive concept now proposed, but rather of illustrating and making understandable the conceptual innovations revealed in this solution. Thus, the descriptions and images must be interpreted in an illustrative and non-limiting way, and there may be other equivalent or analogous forms of implementing the inventive concept now revealed and that do not escape the spectrum of protection outlined in the proposed solution.

1.-FREE PISTON ENGINE, characterized by being formed by an arrangement of three or more pistons (4), which are coupled to the polygonal ring (3) in a sliding way and limited by the tabs (8) of the staple (6) mounted on the said ring (3); the ring (3) has in the center an eccentric (2) that together transforms the linear movement of the pistons (4) into circular motion to the shaft (1), being that the shaft (1) is welded or fixed to the eccentric (2); the said shaft (1) is through, crosses both sides, for coupling to one or more external equipment in one or both ends, being closed by two support covers in front and behind the block (5) for the shaft, block this that is main structure of support.

2.-FREE PISTON ENGINE, according to claim 1, and characterized by alternatively the polygonal ring (3) which has sides corresponding to the number of pistons (4) can also be cylindrical, having a proportional space for allocation of components.

3.-FREE PISTON ENGINE, according to claim 1, and characterized by the combustion cylinder heads being placed externally in front of the pistons (4) fixed in the block (5) to form the combustion chamber and include synchronized valves.

4.-FREE PISTON ENGINE, formed by an arrangement of one or two pistons (4) which are integrated to the blocks (5A), and are fixed, welded or integrated into a coupling structure (7), characterized by the said coupling structure (7) to receive internally the four-sided polygonal ring (3), in which the pistons (4) slide only through two opposite sides of the ring (3), being positioned orthogonally to the shaft (1) joined to the eccentric (2), inserted in the ring (3).
